(19) United States
(12) Patent Application Publication
(10) Pub. No.: US 2014/0068443 A1
(43) Pub. Date: Mar. 6, 2014

(54) METHOD AND SYSTEM FOR CREATING MNEMONICS FOR LOCATIONS-OF-INTERESTS

(71) Applicants: Kai Y. Eng, Atlantic Highlands, NJ (US); Pramod Pancha, Belle Mead, NJ (US)

(72) Inventors: Kai Y. Eng, Atlantic Highlands, NJ (US); Pramod Pancha, Belle Mead, NJ (US)

(73) Assignee: Private Group Networks, Inc., Atlantic Highlands, NJ (US)

(21) Appl. No.: 13/596,193

(22) Filed: Aug. 28, 2012

(51) Int. Cl. G06F 3/01

(52) U.S. Cl. 715/733

(57) ABSTRACT

A method and system for creating an electronic journal entry based on a mnemonic, wherein the mnemonic is created by a terminal in response to receiving a command from a user at a location-of-interest. The mnemonic comprises calendrical time of the command, an audio recording, and a photo that was recorded and captured at that location-of-interest. The user can retrieve the mnemonic from memory at a later time to listen to the audio recording and view the photo to help him recall the details of the location-of-interest. Once the user recalls the details, the journal entry is created by adding text, audio recordings, photos, and videos. As part of creating the journal entry, the user can provide authorization information for the journal entry. Once the user has finished creating the journal entry, the terminal transmits it to a data-processing system where an electronic journal of the user is updated.

### FIELD OF THE INVENTION

The present invention pertains to a method for creating electronic journal entries based on the mnemonics.

### BACKGROUND OF THE INVENTION

Electronic diaries in the prior art allow users to exploit the geo-location capabilities of their wireless phones to create a more compelling experience.

The “check-in” feature provided by such electronic diaries is one example. As the phrase denotes, this feature allows a user to update his presence information on a timeline-based, electronic diary to indicate that he is currently at an establishment of interest (e.g., a restaurant, a stadium, a supermarket, etc.). However, these diaries require the user to perform a series of vigorous steps in real-time to update his presence information. These steps include:
(i) executing the electronic diary on a wireless phone while at an establishment of interest;
(ii) invoking the check-in feature of the electronic diary displayed on the phone;
(iii) waiting for a server to send a predefined menu of establishments that are within the vicinity of the phone's geo-location;
(iv) sorting through the predefined menu by the user to find the establishment of interest; and
(v) optionally including media as part of the check-in process.
   Requiring the user to perform these steps in real-time distracts the user from participating in or experiencing certain activities while at the establishment. This either negatively impacts the user's enjoyment or becomes something of a deterrent to using the electronic diary.

As another example, a user can update the presence information on his timeline-based, electronic diary by uploading a photo with a textual description. The user can use the geo-tag of the photo to recall the details of the event or location while updating his electronic diary. However, the information represented by the geo-tag is limited, and for situations where no photo is taken, this method offers little or no assistance with helping the user recall the location or event.

Even if photos are always taken by the user, it is not uncommon for the user to update his electronic diary a few days, weeks, or months later. In this regard, another drawback of these electronic diaries is that the photos are automatically stored in the phone without any contextual information about the photos. When the user reviews the photos at a later time, he is forced to recall the details of the event or location. This is likely to result in an incomplete description of the event, or the user may not remember why the photos were even taken.

### SUMMARY OF THE INVENTION

The present invention cures the above deficiencies by providing a minimally intrusive method and system for creating electronic journal entries based on mnemonics.

According to one illustrative embodiment of the present invention, when a user arrives at a location or event deemed worthwhile to remember (i.e., location-of-interest), the user can execute an application software on his terminal to display a button labeled, “pin,” for example. The user simply makes a single tap, swipe, etc. of the button, and the application software will automatically obtain the current geo-location of the terminal as well as the date and time (i.e., calendrical time) of the “pin” command. The command will also activate an audio recorder of the user's terminal for a predefined time (e.g., one second, four seconds, ten seconds, etc.) so that the user can record a word, a phrase, or a sentence about the location-of-interest. Once recorded, the user's terminal associates the current geo-location with the calendrical time and audio recording to form a single mnemonic record for that location-of-interest. If a photo of the location-of-interest is captured by the user, the terminal likewise associates the photo with the mnemonic record. The mnemonic is subsequently stored in a memory of the terminal such that the user can retrieve it at a later time.

This pinning feature of the present invention can be performed by the user at different times throughout the day as he arrives at other locations-of-interests. One advantage of this feature is that the user does not need to perform a series of steps in real-time to update his electronic journal. Instead, the user can simply perform the pinning command once, and enjoy his experience at the location or event.

Whenever the user has time to create a journal entry, which can be days, weeks, or even months after performing the last pinning command, the present invention provides a way to help the user recall the details of the locations-of-interests.

In particular, the user can launch the application software on the terminal at a later time to view locations-of-interests that were pinned in the past. A list-view is one example, where each pinned location-of-interest is organized in the list based on its respective geo-location. Each pinned location-of-interest is displayed in the list with a mnemonic that comprises at least one of, or any combination of, calendrical time, audio recordings, photos, and videos.

The user can select an audio recording of a particular mnemonic in the list to play the audio that was recorded at the location-of-interest of that mnemonic. Similarly, the user can select a photo of a particular mnemonic to view the image that was captured at the location-of-interest of that mnemonic.

Once the user recalls the details of the location-of-interest based on the calendrical time, audio recording, photo, and video of a mnemonic, the user can launch a new screen on the terminal to create the journal entry. The journal entry can be created by adding text, photos, audio recordings, videos, etc. As part of this process, the user can also provide authorization information such that the journal entry can be viewed only by the user, or shared with friends or the public. Once created, the journal entry is transmitted from the terminal to a data-processing system where an electronic journal of the user is updated.

In one illustrative embodiment of the present invention, when a mnemonic is displayed in the list under an identifier labeled “Map,” for example, this identifier signifies to the user that the location-of-interest associated with the mnemonic can be displayed on a map of the terminal. When the user selects this identifier, the user's terminal displays the location-of-interest on the map using the GPS coordinate obtained by the terminal at the time of receiving the pin command for that location-of-interest.

In another illustrative embodiment of the present invention, when the mnemonic is displayed in the list under an identifier labeled “Unnamed,” for example, this identifier signifies to the user that the location-of-interest does not have a GPS coordinate and a name. When the user selects this identifier, the terminal displays a list of Service Set Identifiers (SSIDs) to help the user recall and assign a name to the location-of-interest.

In a further illustrative embodiment of the present invention, the user can use the application software to display locations-of-interests of his friends, family, co-worker, etc., on a map of the terminal. This feature of the present invention is advantageous as it allows the user to view other locations-of-interests that might be considered interesting, relevant, or useful to the user.

These features of the present invention will be described in more detail below, with reference to the accompanying figures.

### BRIEF DESCRIPTION OF THE DRAWINGS

FIG. 1 depicts a diagram of some components of a telecommunications system according to an illustrative embodiment of the present invention.

FIG. 2 depicts a block diagram of some elements of a telecommunications terminal according to an illustrative embodiment of the present invention.

FIG. 3 depicts a block diagram of some elements of a data-processing system according to an illustrative embodiment of the present invention.

FIG. 4 depicts a flowchart of the operations in accordance with an illustrative embodiment of the present invention.

FIG. 5 depicts a flowchart of the operations of task 402 in accordance with an illustrative embodiment of the present invention.

FIG. 6 depicts a flowchart of the operations of task 506 in accordance with an illustrative embodiment of the present invention.

FIG. 7 depicts a list-view of pinned locations-of-interests displayed by a telecommunications terminal in accordance with an illustrative embodiment of the present invention.

FIG. 8 depicts a flowchart of the operations of task 408 in accordance with an illustrative embodiment of the present invention.

FIG. 9 depicts a user's location-of-interest superimposed on a map displayed by a telecommunications terminal when a user selects an identifier from a list in accordance with an illustrative embodiment of the present invention.

FIG. 10 depicts a flowchart of the operations for assigning a name to a location-of-interest based on a list of Service Set Identifiers (SSIDs) in accordance with an illustrative embodiment of the present invention.

FIG. 11 depicts a flowchart of the operations for displaying a user's location-of-interest and another user's location-of-interest superimposed on a map in accordance with an illustrative embodiment of the present invention.

FIG. 12 depicts a user's location-of-interest and another user's location-of-interest superimposed on a map displayed by a telecommunications terminal in accordance with an illustrative embodiment of the present invention.

### DETAILED DESCRIPTION

For the purpose of this specification and the claims, the phrase “calendrical time” is defined as the date and time of when a terminal receives a command from a user.

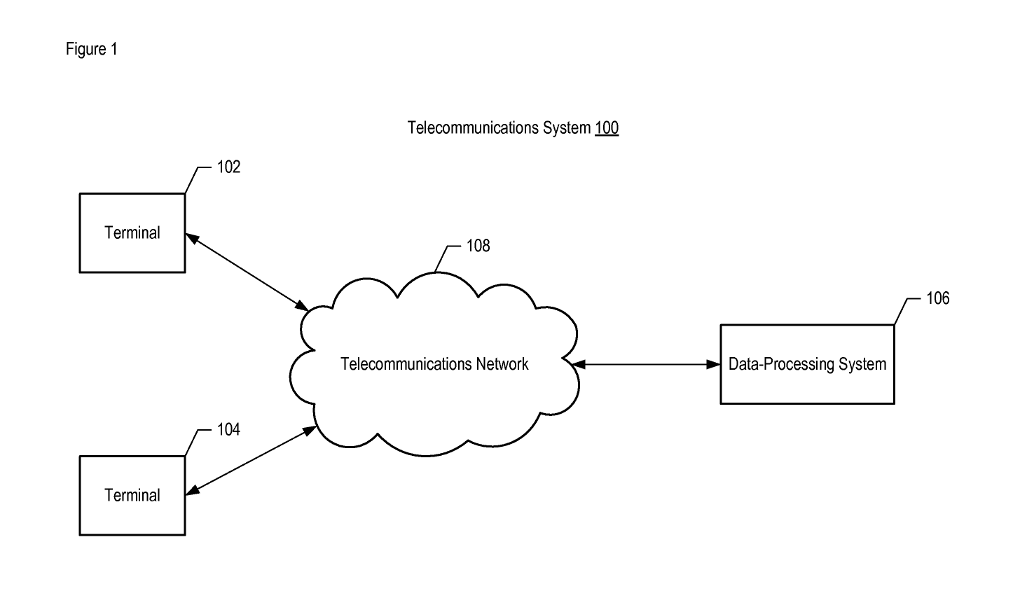

FIG. 1 depicts a diagram of some components of telecommunications system 100 according to an illustrative embodiment of the present invention. Telecommunications system 100 comprises: telecommunications terminal 102; telecommunications terminal 104; data-processing system 106; and telecommunications network 108.

Although the illustrative embodiment comprises two telecommunications terminals, it will be clear to those skilled in the art, after reading this specification, how to make and use alternative embodiments of the present invention that comprises any number of telecommunications terminals.

According to the illustrative embodiment of the present invention, telecommunications terminal 102 is a wireless terminal that comprises the necessary hardware and software to perform the processes described below and in the accompanying figures. As will be clear to those skilled in the art, a wireless terminal is also known as a “cell phone,” “smart phone,” “mobile station,” “car phone,” “personal-digital-assistant (PDA),” and the like.

Terminal 102 is capable of communicating via one or more air-interface standards, such as Code Division Multiple Access (CDMA), Institute of Electrical and Electronics Engineers (IEEE) 802.11, Wi-Fi, WiMax, Bluetooth, etc. Terminal 102 is also capable of wirelessly transmitting and receiving electromagnetic signals to and from telecommunications network 108 via a wireless transceiver, in well-known fashion, and of estimating and reporting its geo-location. As will be appreciated by those skilled in the art, there are a variety of well-known techniques by which terminal 102 can determine its geo-location based on received electromagnetic signals, such as via a Global Positioning System (GPS) receiver, via triangulation, and so forth. It will be clear to those skilled in the art, after reading this specification, how to make and use alternative embodiments of the present invention in which the geo-location of terminal 102 is determined by an entity other than the terminal itself.

The software, hardware, and capabilities of telecommunications terminal 104 are substantially the same as terminal 102 discussed above. However, it will be clear to those skilled in the art, after reading this specification, how to make and use alternative embodiments of the present invention in which terminal 104 comprises all or some of the software, hardware, and capabilities of terminal 102.

Although the illustrative embodiment comprises one data-processing system, it will be clear to those skilled in the art, after reading this disclosure, how to make and use alternative embodiments of the present invention that comprises any number of data-processing systems. In the illustrative embodiment, data-processing system 106 is a server that comprises the necessary hardware and software to perform the processes described below and in the accompanying figures. In general, data-processing system 106 is capable of transmitting and receiving electromagnetic signals to and from terminals 102 and 104 via telecommunications network 108, updating an electronic journal of a user, and notifying other users of such updates. It will be clear to those skilled in the art, after reading this specification, how to make and use alternative embodiments of the present invention in which data-processing system 106 is a network element that is other than a server.

Telecommunications network 108 is well-known in the art. In the illustrative embodiments, network 108 is the Internet. In other embodiments, network 108 is the Public Switched Telephone Network (PSTN), a private data network, etc. It will be clear to those skilled in the art, after reading this specification, how to make and use alternative embodiments of the present invention in which network 108 is one or more of the above-mentioned networks.

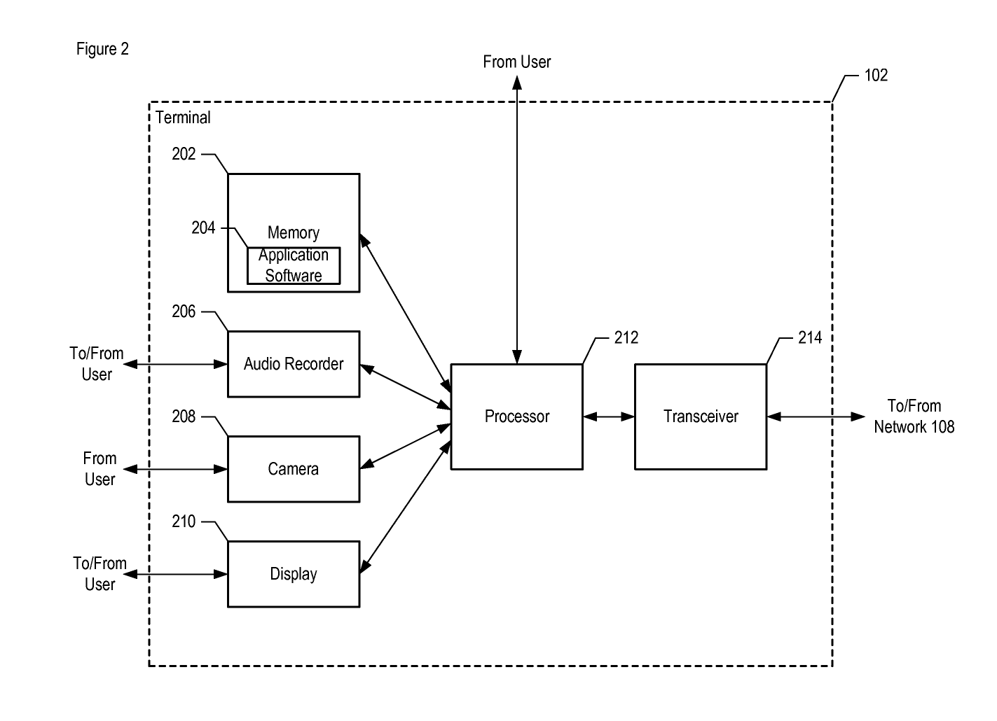

FIG. 2 depicts a block diagram of some elements of telecommunications terminals 102 and 104 according to an illustrative embodiment of the present invention. As depicted in FIG. 2, terminals 102 and 104 comprise: memory 202; application software 204; audio recorder 206; camera 208; display 210; processor 212; and transceiver 214, interconnected as shown. FIG. 2 also depicts signals encoded with information that are transmitted to and received from telecommunications network 108.

Memory 202 stores data and executable instructions, as is well-known in the art. Memory 202 can be any combination of random-access memory (RAM), flash memory, disk drive, etc. It will be clear to those skilled in the art, after reading this specification, how to make and use memory 202. As will be further discussed below, memory 202 stores application software 204 which, when executed by processor 212, enables a user to create and store one or more mnemonics through a single tap, swipe, etc. of a soft-button displayed by terminal 102. Application software 204 also enables a user to create a journal entry based on the one or more mnemonics. Application software 204 will be described in more detail below, with reference to the accompanying figures.

Audio recorder 206 is capable of recording a word, a phrase, a sentence, background noise, etc., at a location-of-interest. In general, audio recorder 206 is automatically activated by terminal 102 for a predefined time when the user invokes a soft-button displayed by terminal 102 for creating a mnemonic. Once activated, audio recorder 206 enables the user to record audio files at a location-of-interest and store them in memory 202 as part of the mnemonic-creating process. Audio recorder 206 will be described in more detail below, with reference to the accompanying figures.

Camera 208 is capable of capturing both photos and videos, as is well-known in the art. Camera 208 enables the user to capture photos and videos at a location-of-interest, and store them in memory 202 as part of the mnemonic-creating process. Camera 208 will be described in more detail below, with reference to the accompanying figures.

Display 210 is a touch-sensitive display that is capable of receiving input from the user and of transmitting signals representing the input to processor 212 for processing. Display 210 is also capable of displaying photos and videos to the user in well-known fashion as well. Display 210 will be described in more detail below, with reference to the accompanying figures.

Processor 212 is a general-purpose processor that is capable of executing application software 204 and the instructions stored in memory 202 for performing the processes described below and in the accompanying figures. In general, processor 212 is capable of reading data from memory 202, writing data into memory 202, activating audio recorder 206 and camera 208, receiving commands from a user, etc. In some alternative embodiments of the present invention, processor 212 is a special-purpose processor. The processes performed by processor 212 in accordance with the illustrative method will be described in more detail below, with reference to the accompanying figures.

Transceiver 214 comprises a receiving part and a transmitting part. The receiving part receives signals from network 108, and forwards the information encoded in the signals to processor 212 for processing. The transmitting part, on the other hand, receives information from processor 212 and outputs signals encoded with information to network 108. It will be clear to those skilled in the art, after reading this specification, how to make and use transceiver 214.

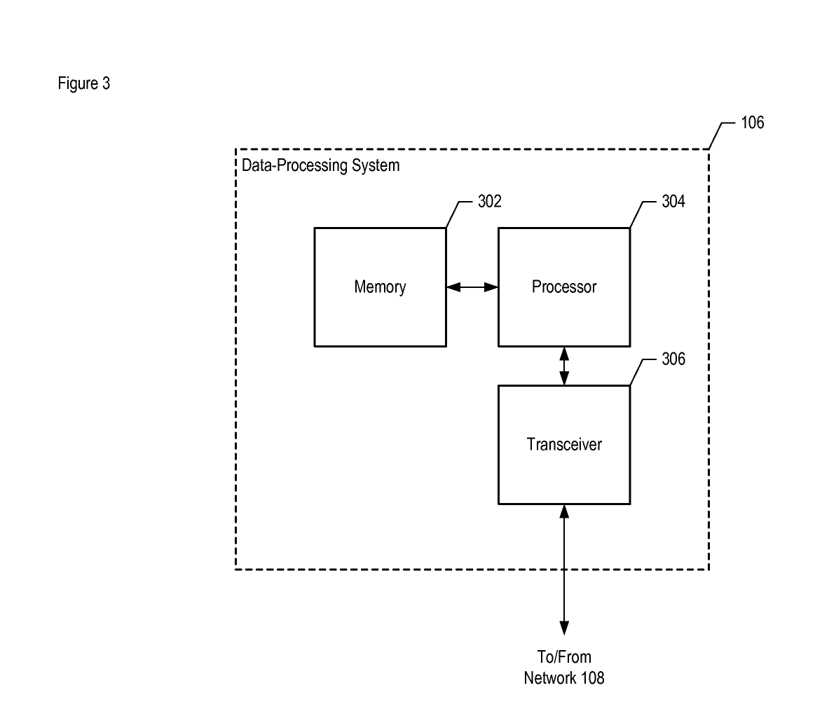

FIG. 3 depicts a block diagram of some elements of data-processing system 106 according to an illustrative embodiment of the present invention. As depicted in FIG. 3, data-processing system 106 comprises: memory 302; processor 304; and transceiver 306, interconnected as shown. FIG. 3 also depicts signals encoded with information that are transmitted to and received from telecommunications network 108.

Memory 302 stores data and executable instructions, as is well-known in the art. Memory 302 can be any combination of random-access memory (RAM), flash memory, disk drive, etc. It will be clear to those skilled in the art, after reading this specification, how to make and use memory 302. As will be further discussed below, memory 302 stores executable instructions which, when executed by processor 304, enables data-processing system 106 to update an electronic journal of a user, as well as other services.

Processor 304 is a general-purpose processor that is capable of executing the instructions stored in memory 302 for performing the processes described below and in the accompanying figure. In general, processor 304 is capable of executing the encoded signals received via telecommunications network 108, reading data from and writing data into memory 302, receiving commands from a terminal via telecommunications network 108, transmitting information to a terminal via network 108, updating a user's electronic journal, notifying other user's of the update, etc. In some alternative embodiments of the present invention, processor 304 is a special-purpose processor. It will be clear to those skilled in the art, after reading this specification, how to make and use processor 304.

Transceiver 306 comprises a receiving part and a transmitting part. The receiving part receives signals from network 108, and forwards the information encoded in the signals to processor 304 for processing. The transmitting part, on the other hand, receives information from processor 304, and outputs signals encoded with information to network 108. It will be clear to those skilled in the art, after reading this specification, how to make and use transceiver 306.

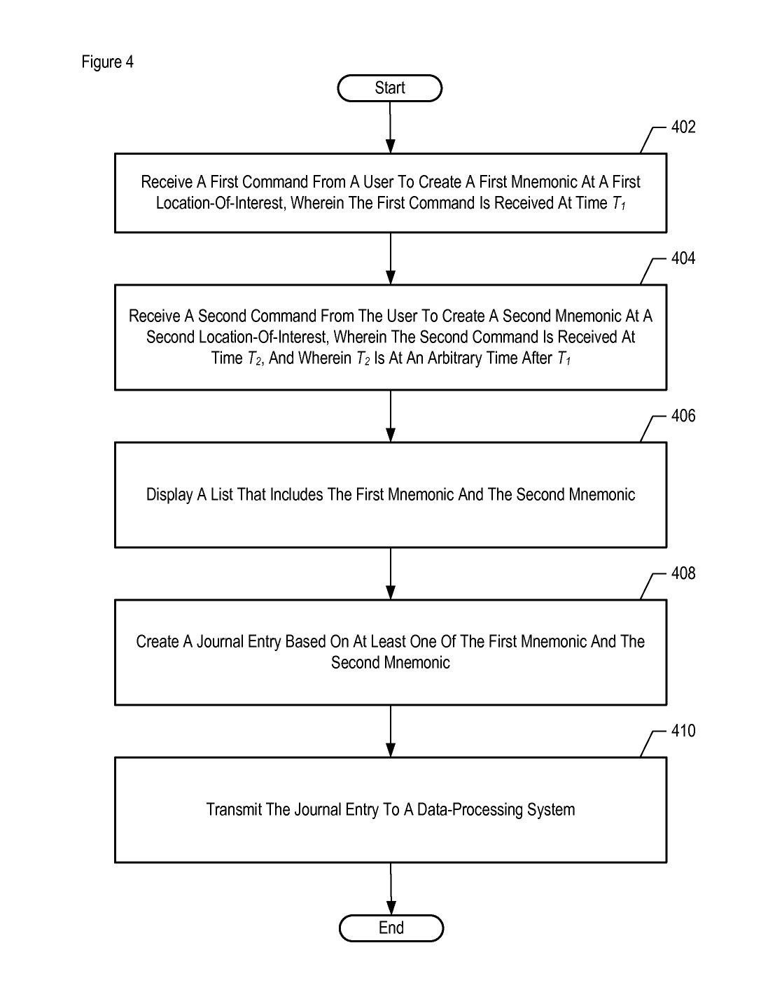

FIG. 4 depicts a flowchart of the operations in accordance with an illustrative embodiment of the present invention. FIG. 4 comprises tasks 402, 404, 406, 408, and 410. It will be clear to those skilled in the art, after reading this specification, how to make and use alternative embodiments of the present invention in which task 402 through task 410 can be performed concurrently, simultaneously, at different times, or in a different order.

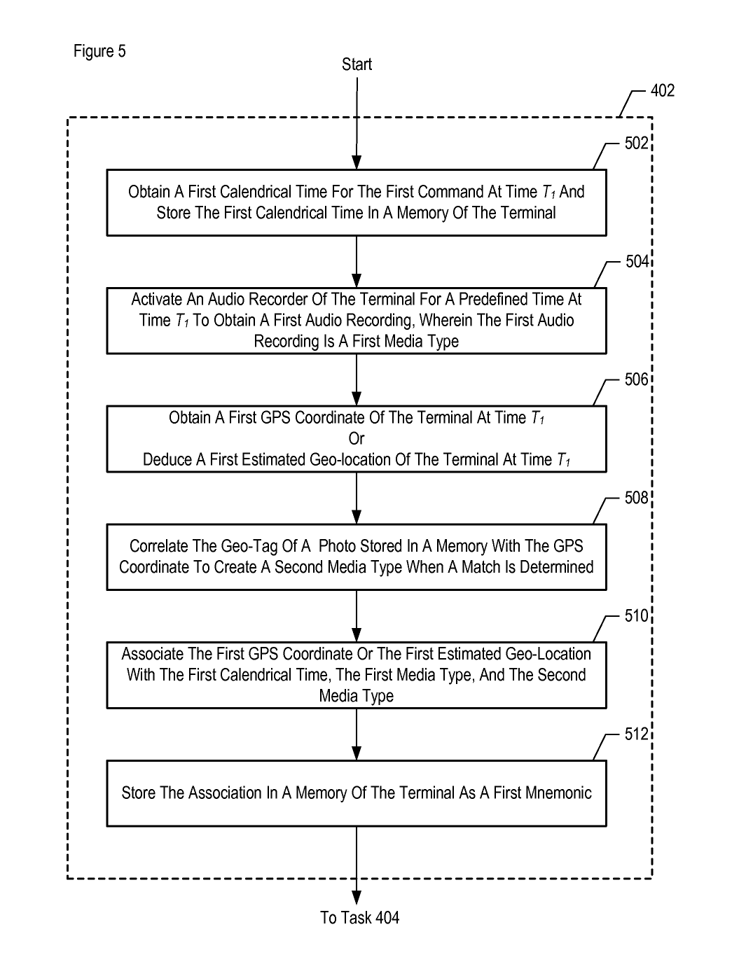

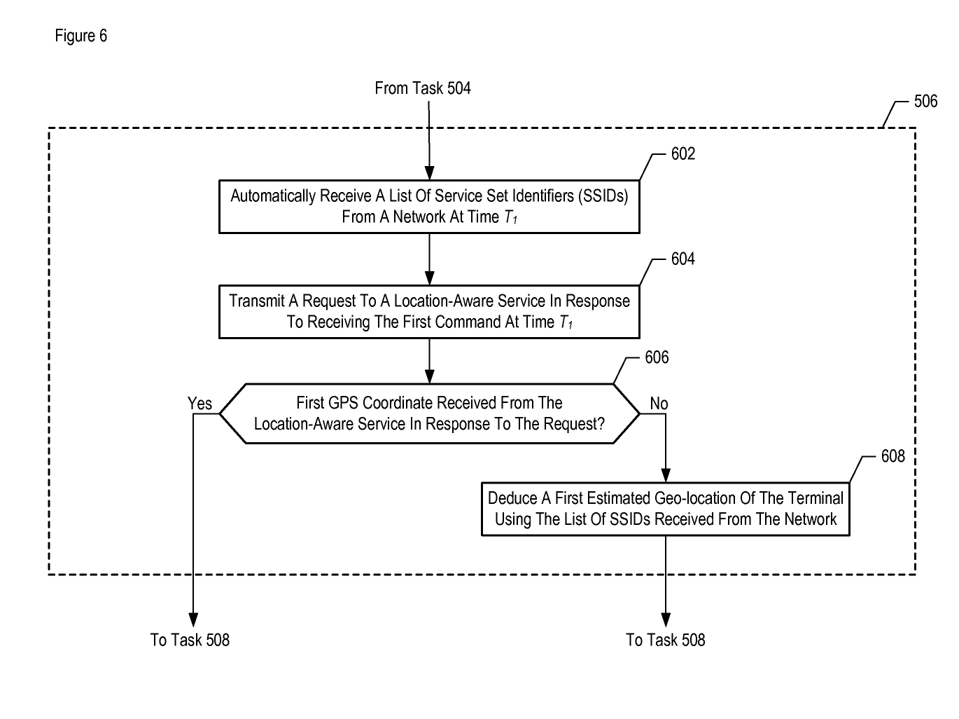

At task 402, a user of telecommunications terminal 102 arrives at a first location-of-interest. While physically at this location, the user executes application software 204 on terminal 102. In response to executing the application software, terminal 102 displays a soft-button labeled “pin,” for example, to the user on display 210. At time T₁, and while physically at the first location-of-interest, the user invokes the “pin” button by performing, for example, and without limitation, a single tap of the button. This single tap of the button represents a first command for terminal 102 to perform various tasks to create a first mnemonic for the first location-of-interest. The tasks performed by terminal 102 in response to receiving the first command at time T₁ will be described in more detail below, with reference to FIG. 5 and FIG. 6.

As the user of terminal 102 travels from the first location-of-interest to other geo-locations, the user may consider one or more of these other geo-locations to be of interests. At task 404, the user of terminal 102 arrives at a second location-of-interest. While physically at this location, the user executes application software 204 on terminal 102. In response to executing the application software, terminal 102 displays a soft-button labeled “pin” to the user on display 210. At time T₂, and while physically at the second location-of-interest, the user invokes the “pin” button by performing a single tap of the button. This single tap of the button represents a second command for the terminal to perform certain tasks to create a second mnemonic for the second location-of-interest. The tasks performed by terminal 102 in response to receiving the second command at time T₂ will be described in more detail below, with reference to FIG. 5 and FIG. 6.

It is notable that the second command received by terminal 102 at time T₂ is at an arbitrary time after time T₁. For example, and without limitation, the second command received by terminal 102 at time T₂ could be, for example, one or more hours, days, weeks, or months after the first command at time T₁.

At task 406, the user executes application software 204 on terminal 102, which occurs, for example, and without limitation, one or more hours, days, weeks, or months after the last pinned location. In response to executing application software 204, terminal 102 displays the “pin” button, as well as another soft-button labeled, for example, “list.” By invoking the “list” button on display 210, terminal 102 displays a list-view of “pinned” locations-of-interests. This list displayed to the user includes, for example, the first mnemonic for the first location-of-interest, and the second mnemonic for the second location-of-interest. In general, each mnemonic in the list is displayed with calendrical time and at least one of, or any combination of, an audio recording, a photo, a video, etc. that was recorded or captured at their respective location-of-interest.

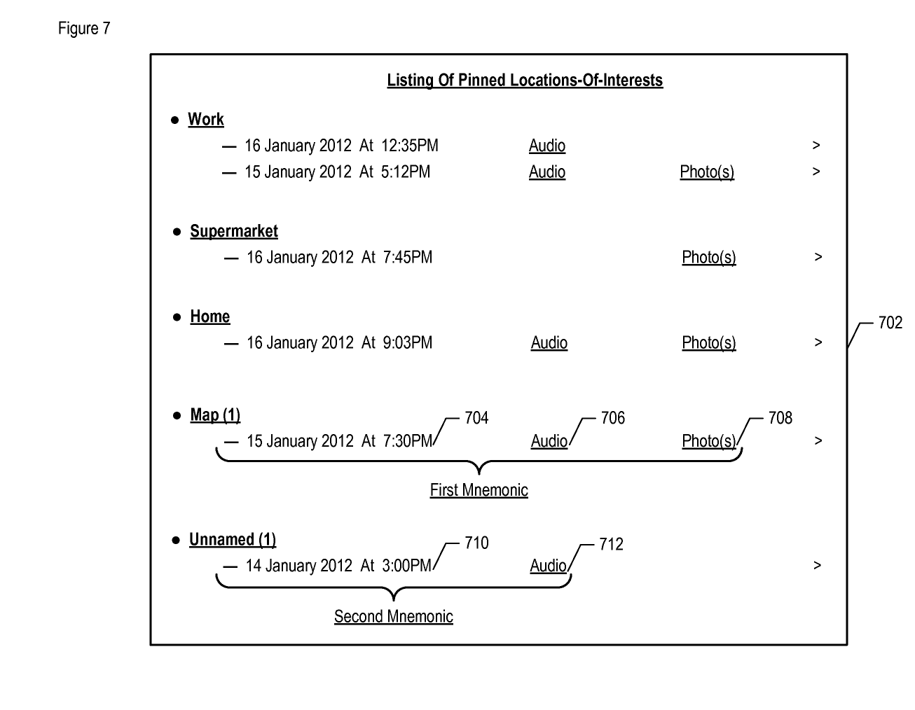

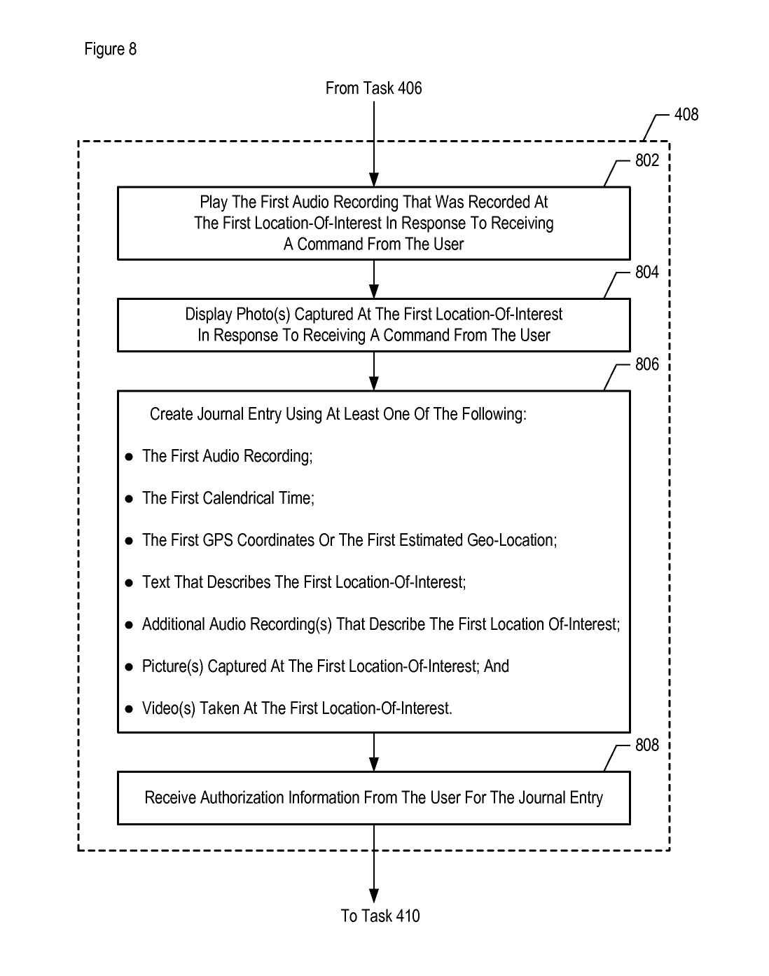

For example, terminal 102 displays the list to the user on display 210 when the user invokes the “list” button. The list includes the first mnemonic for the first location-of-interest. The first mnemonic in this example is displayed in the list with calendrical time, an audio recording, and a photo that was recorded and captured by the user at the first location-of-interest. As further discussed below, with reference to FIG. 7 and FIG. 8, these different types of media can be selected from the list and communicated to the user.

At task 408, the user creates a journal entry based on at least one of the first mnemonic and the second mnemonic. In the illustrative embodiment, the user creates a journal entry for the first location-of-interest based on the first mnemonic. To recall the details of the first location-of-interest, the user selects, for example, an audio recording associated with the first mnemonic from the list. In response to the user's selection, terminal 102 retrieves the audio recording from memory 202, and plays the audio recording to the user. The audio recording can be, for example, and without limitation, the user's voice, another user's voice, background noise, etc. recorded at the first location-of-interest. The user can also select the photo associated with the first mnemonic from the list to further assist him in remembering the first location-of-interest. In response to the user's selection, terminal 102 retrieves the photo from memory 202, and displays the photo to the user. Once the user recalls the details of the first location-of-interest based on the audio recording and/or the photo, the user creates the journal entry in a new screen by providing, for example, and without limitation, text, an audio recording, a photo, a video, etc. As part of creating the journal entry, the user can also provide authorization information such that the journal entry can be viewed only by the user, or shared with friends or the public. The tasks of creating the journal entry will be described in more detail below, with reference to FIG. 8.

At task 410, terminal 102 receives a command from the user to transmit the journal entry to data-processing system 106 via telecommunications network 108. Data-processing system 106 receives the journal entry from terminal 102 and stores it in memory 302, along with the information used to create the journal entry. Once stored, data-processing system 106 will update an electronic journal of the user based on the journal entry and, depending on the authorization information provided by the user, notify other users of the update.

FIG. 5 depicts a flowchart of the operations of task 402 for receiving a first command from a user to create a first mnemonic in accordance with an illustrative embodiment of the present invention. FIG. 5 comprises tasks 502, 504, 506, 508, 510, and 512. It will be clear to those skilled in the art, after reading this specification, how to make and use alternative embodiments of the present invention in which at least some of tasks 502 through 512 are performed concurrently, simultaneously, at different times, or in a different order.

At task 502, terminal 102 obtains the calendrical time of the first command. The calendrical time represents the date and time of when the user invoked the “pin” button on display 210 at time T₁. In the illustrative embodiment of the present invention, terminal 102 obtains the calendrical time of the first command by using its own digital clock to record the date and time of when the user invoked the “pin” button at time T₁. Once obtained, terminal 102 stores the calendrical time in memory 202.

At task 504, terminal 102 activates audio recorder 206 for a predefined time. Once activated, the user records a word, a phrase, a sentence, or background noise to help him remember the first location-of-interest at a later time. In the illustrative embodiment, the user records his voice, while in other embodiments, the user records, for example, and without limitation, another user's voice or background noise at the first location-of-interest. Furthermore, the predefined time of the audio recorder 206 is five seconds in the illustrative embodiment, while in other embodiments, the predefined time is greater or less than five seconds (e.g., four seconds, ten seconds, fifteen seconds, etc.). Once created, terminal 102 stores the audio recording in memory 202 as a first media type.

At task 506, terminal 102 transmits a request to a location-aware service to obtain a Global Positioning System (GPS) coordinate that is indicative of terminal 102's geo-location at time T₁. Once obtained, terminal 102 stores the GPS coordinate in memory 202. However, if terminal 102 is unable to obtain the GPS coordinate from the location-aware service, terminal 102 automatically deduces an estimate of its own geo-location using a list of Service Set Identifiers (SSIDs) received by a nearby Wireless Local Area Network (WLAN) at the first location-of-interest. Once deduced, the estimated geo-location is stored in memory 202. Task 506 will be described in more detail below, with reference to FIG. 6.

At task 508, terminal 102 correlates the geo-tag of one or more photos stored in memory 202. When terminal 102 determines that the geo-tag of one or more photos matches the GPS coordinate or estimated geo-location obtained at task 506, terminal 102 uses the photos as a second media type.

At task 510, terminal 102 associates the GPS coordinate or the estimated geo-location with the calendrical time, the audio recording, and the photos. At task 512, terminal 102 stores the association in memory 202, thereby creating a first mnemonic for the first location-of-interest.

Tasks 502 through 512 are also used to perform task 404 for receiving a second command from a user to create a second mnemonic in accordance with an illustrative embodiment of the present invention.

FIG. 6 depicts a flowchart of the operations of task 506 in accordance with an illustrative embodiment of the present invention. FIG. 6 comprises tasks 602, 604, 606, and 608. It will be clear to those skilled in the art, after reading this specification, how to make and use alternative embodiments of the present invention in which at least some of tasks 602 through 608 are performed concurrently, simultaneously, at different times, or in a different order.

At task 602, terminal 102 automatically receives a list of Service Set Identifiers (SSIDs) broadcasted by nearby a Wireless Local Area Networks (WLAN) at the first location-of-interest. In other embodiments of the present invention, terminal 102 also receives Media Access Control (MAC) addresses broadcasted by the nearby WLAN at the first location-of-interest. As will be appreciated by those skilled in the art, the SSIDs, MAC addresses, or a combination thereof, form a Wi-Fi signature of the WLAN at the first location-of-interest.

At task 604, terminal 102 transmits a request to a location-aware service to obtain a Global Positioning System (GPS) coordinate that is indicative of terminal 102's geo-location at T₁. In the illustrative embodiment, terminal 102 obtains the GPS coordinate by transmitting a request to, and receiving a response from, a remote location-aware service. This remote location-aware service can be, for example, and without limitation, data-processing system 106, a server, a base station of a cell-tower, etc. In other embodiments, terminal 102 determines its own geo-location based on received electromagnetic signals, such as via a GPS receiver, via triangulation, and so forth.

At task 606, terminal 102 determines if a response to the request is received from the location-aware service. If a response is received, terminal 102 stores the GPS coordinates in memory 202 and the illustrative embodiment proceeds to task 508 of FIG. 5. On the other hand, if a response is not received from the location-aware service, the illustrative embodiment proceeds to task 608.

At task 608, terminal 102 uses the list of SSIDs broadcasted by nearby WLANs at the first location-of-interest to deduce an estimate of its own geo-location at time T₁. Once deduced, terminal 102 stores the estimated geo-location in memory 202 and the illustrative embodiment proceeds to task 508 of FIG. 5.

Tasks 602 through 608 are also used to obtain a GPS coordinate or an estimated geo-location for the second location-of-interest.

FIG. 7 depicts a list-view of “pinned” locations-of-interests displayed by a telecommunications terminal in accordance with an illustrative embodiment of the present invention.

As discussed above with reference to task 406 of FIG. 4, the user executes application software 204 on terminal 102 and invokes a “list” button. In response, terminal 102 displays list 702 to the user. In the illustrative embodiment, calendrical time 704, audio identifier 706, and photo identifier 708 correspond to the first mnemonic for the first location-of-interest, which is organized under the identifier “Map(1).” The user can select, from list 702, audio identifier 706 of the first mnemonic to play the audio recording that was recorded at the first location-of-interest. Similarly, the user can select, from list 702, photo identifier 708 of the first mnemonic to view one or more photos that were captured at the first location-of-interest. As another example of the illustrative embodiment, calendrical time 710 and audio identifier 712 correspond to the second mnemonic for the second location-of-interest, which is organized under the identifier “Unnamed(1).” The user can select, from list 702, audio identifier 712 of the second mnemonic to play the audio recording that was recorded at the second location-of-interest. Again, the intent of reviewing the audio, photo(s), etc., that form the mnemonic is to refresh the user's recollection of the location-of-interest toward the end of preparing an electronic journal entry. Once terminal 102 displays list 702 to the user, the illustrative embodiment proceeds to task 408 for creating a journal entry.

FIG. 8 depicts a flowchart of the operations of task 408 in accordance with an illustrative embodiment of the present invention. FIG. 8 comprises tasks 802, 804, 806, and 808. It will be clear to those skilled in the art, after reading this specification, how to make and use alternative embodiments of the present invention in which at least some of tasks 802 through 808 are performed concurrently, simultaneously, at different times, or in a different order.

At task 802, the user selects audio identifier 706 of the first mnemonic from list 702. In response, terminal 102 retrieves the audio recording associated with the identifier from memory 202 and plays it to the user. Viewing the photo further reminds the user of the first location-of-interest.

At task 804, the user selects photo identifier 708 of the first mnemonic from list 702. In response, terminal 102 retrieves the one or more photos associated with the identifier from memory 202 and presents them to the user. The user views the photo and is further reminded of the first location-of-interest.

At task 806, the user launches a new screen to create a journal entry based on the first mnemonic—i.e., after listening to the audio recording and viewing the calendrical time and the photos. In this new screen, the user can include at least one of the following types of media to create the journal entry for the first location-of-interest:
(i) the calendrical time obtained by terminal 102 at task 502;
(ii) the audio recording obtained by terminal 102 at task 504;
(iii) the GPS coordinate or estimated geo-location obtained by terminal 102 at task 506;
(iv) text provided by the user via terminal 102 that describes the first location-of-interest;
(v) one or more additional audio recordings stored in memory 202 of terminal 102 that describe the first location-of-interest;
(vi) one or more photos captured at the first location-of-interest and stored in memory 202 of terminal 102;
(vii) one or more videos taken at the first location-of-interest and stored in memory 202 of terminal 102; or
(viii) any combinations of (i) through (vii) above.
   It will be clear to those skilled in the art, after reading this specification, how to make and use alternative embodiments of the present invention in which terminal 102 retrieves the above media from a data-processing system via telecommunications network 108 to create the journal entry.

At task 808, the user provides authorization information for the journal entry. This authorization information provided by the user instructs data-processing system 106 to either make the journal entry private or public. In other words, if the authorization information is to make the journal entry private, only the user can view the journal entry. On the other hand, if the authorization information is to make the journal entry public, the user can choose a selected group of users (e.g., family, co-workers, friends, etc.) from a list, or allow all users in the public domain to view the journal entry. Once the user has created the journal entry and provided the authorization information via terminal 102, the illustrative embodiment proceeds to task 410.

At task 410, terminal 102 transmits the journal entry and the authorization information to data-processing system 106 in response to receiving a command from the user. Once received, data-processing system 106 stores the journal entry and the authorization information in memory 302, and updates the user's electronic journal based on the journal entry. Depending on the authorization information provided by the user, data-processing system 106 will notify other users of the update by transmitting a notification to their terminals.

Tasks 802 through 808 are also used to create a journal entry for the second location-of-interest based on the second mnemonic.

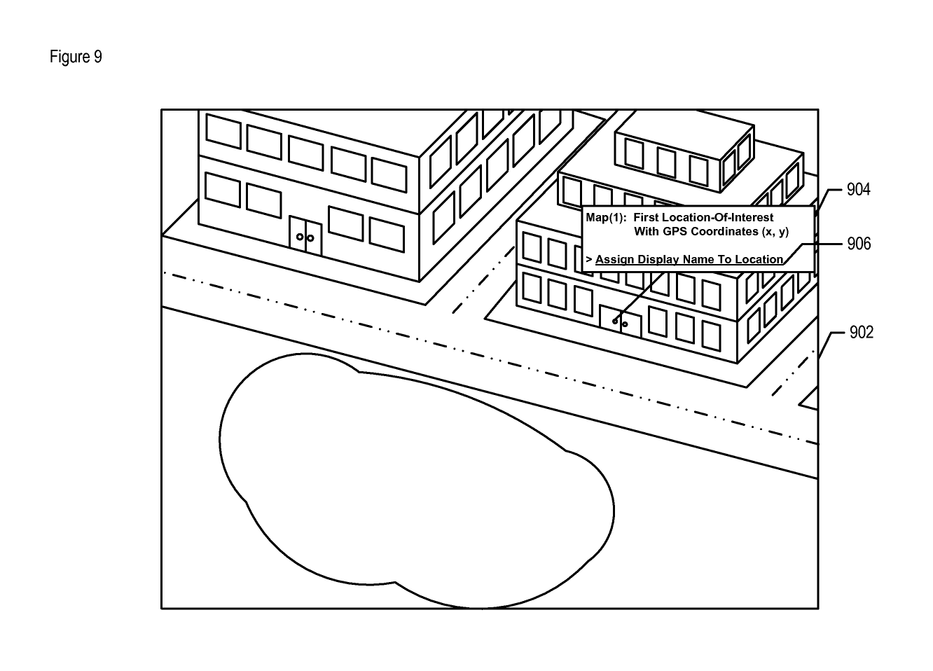

FIG. 9 depicts a map displayed by terminal 102 when a user selects an identifier from list 702 of FIG. 7 in accordance with an illustrative embodiment of the present invention.

As discussed above, FIG. 7 depicts a list of pinned locations-of-interests 702 that includes, among other mnemonics, the first mnemonic for the first location-of-interest. In the illustrative embodiment of the present invention, the first mnemonic for the first location-of-interest is organized under the identifier “Map(1).” This identifier signifies to the user that the first location-of-interest can be displayed on map 902 based on a GPS coordinate obtained by terminal 102 at task 506.

For example, when the user selects the “Map(1)” identifier displayed in list 702, terminal 102 displays the first location-of-interest on map 902 based on the GPS coordinate or the estimated geo-location obtained at task 506. The first location-of-interest 904 is displayed on map 902 with option 906 so that the user can assign a name to the first location-of-interest. Once the user assigns a name to the first location-of-interest, terminal 102 associates the name with the GPS coordinate of the first location-of-interest and stores the association in memory 202. From this point on, the first location-of-interest will always be displayed in list 702 or map 902 under that name.

In other embodiments of the present invention, the first location-of-interest 904 is displayed on map 902 with other locations-of-interest of the user that are within a predefined distance of the first location-of-interest. For example, and without limitation, terminal 102 will display the user's second location-of-interest on map 902 if it is within a hundred yards of the user's first location-of-interest 904. The predefined distance can be pre-programmed into application software 204 or defined by the user via terminal 102.

It will be clear to those skilled in the art, after reading this specification, how to make and use alternative embodiments of the present invention in which map 902 can be any one of, or any combination of, a political map, a physical map, a topographical map, a road map, a satellite map, a street map, etc.

Although the description of FIG. 9 is directed to the first location-of-interest, it will be clear to those skilled in the art, after reading this specification, how to make and use the present invention in which the description of FIG. 9 also applies to the second location-of-interest.

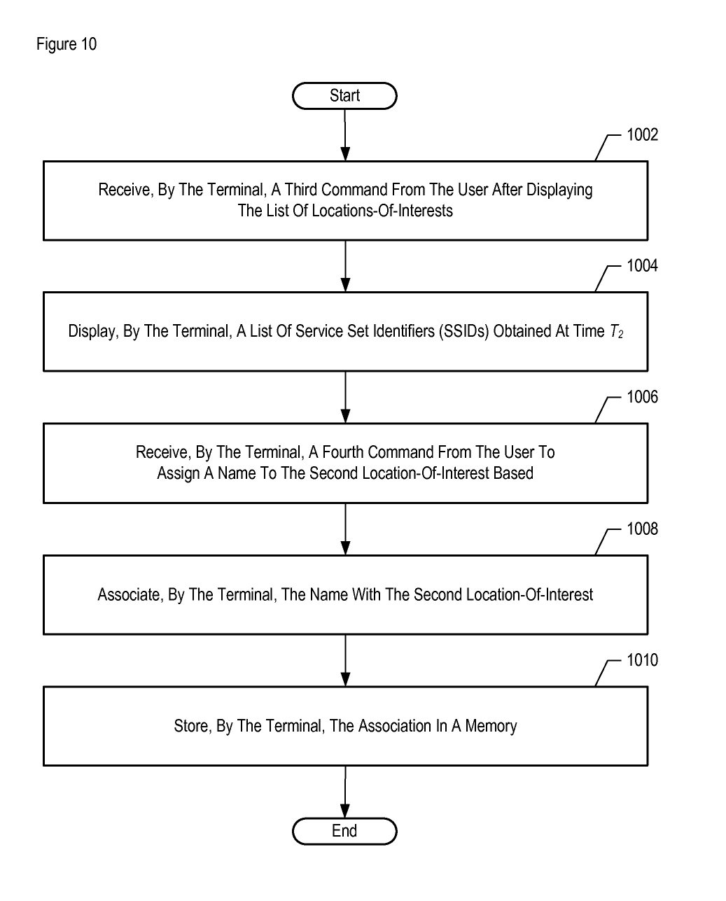

FIG. 10 depicts a flowchart of the operations for assigning a name to a location-of-interest based on a list of Service Set Identifiers (SSIDs) in accordance with an illustrative embodiment of the present invention. FIG. 10 comprises tasks 1002, 1004, 1006, 1008, and 1010. It will be clear to those skilled in the art, after reading this specification, how to make and use alternative embodiments of the present invention in which at least some of tasks 1002 through 1010 can be performed concurrently, simultaneously, at different times, or in a different order.

As discussed above, FIG. 7 depicts a list of “pinned” locations-of-interests 702 that includes, among other mnemonics, the second mnemonic for the second location-of-interest. In the illustrative embodiment of the present invention, the second mnemonic for the second location-of-interest is organized under the identifier “Unnamed (1).” This identifier signifies to the user that the second location-of-interest does not have a Global Positioning System (GPS) coordinate and has not yet been assigned a name. As discussed in more detail below, a single tap of the “Unnamed(1)” identifier displays the list of Service Set Identifiers (SSIDS) that was used to deduce an estimated geo-location of terminal 102 at time T₂ when no GPS coordinate was received from a location-aware-service.

At task 1002, the user of terminal 102 reviews the list of “pinned” locations-of-interests 702 and selects the “Unnamed(1)” identifier. The user's selection of the identifier represents a third command for terminal 102 to display the list of SSIDs obtained at time T₂. At task 1004, terminal 102 displays the list of SSIDs to the user as a mnemonic. The list of SSIDs is a mnemonic because it can be used to help the user recall the second location-of-interest. At task 1006, the user recalls the second location-of-interest based on the list of SSIDs and assigns a name to the second location-of-interest. At task 1008, terminal 102 associates the name with the second location-of-interest and stores the association in memory 202 at task 1010 so that the second location-of-interest will always be displayed in list 702 or map 902 under that name.

Although the description of FIG. 10 is directed to the second location-of-interest, it will be clear to those skilled in the art, after reading this specification, how to make and use the present invention in which the description of FIG. 10 also applies to the first location-of-interest.

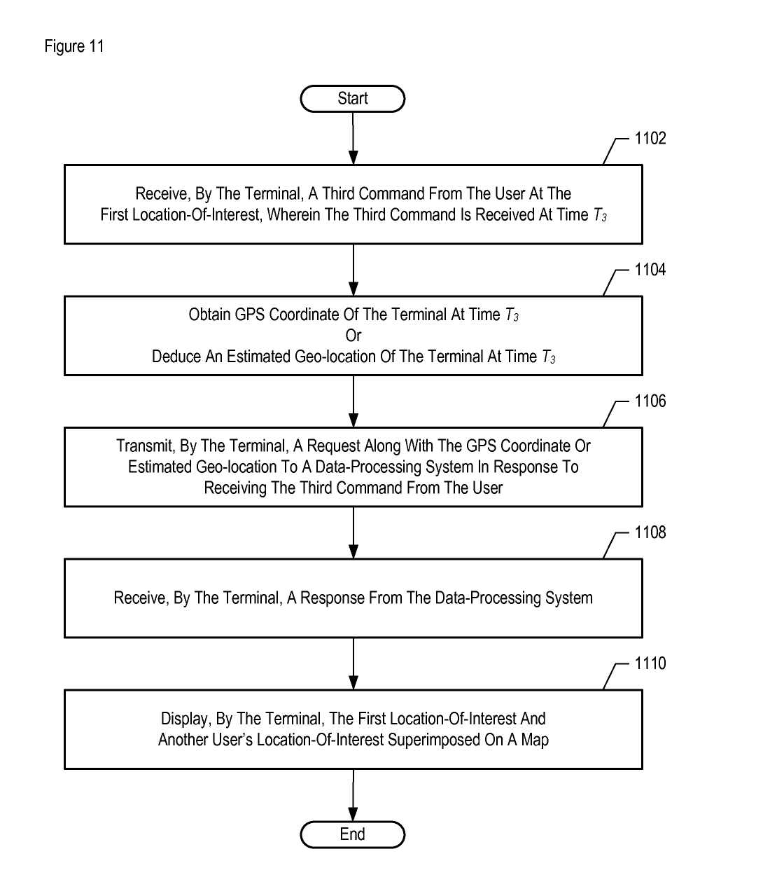

FIG. 11 depicts a flowchart of the operations for displaying a user's location-of-interest and another user's location-of-interest superimposed on a map in accordance with an illustrative embodiment of the present invention. FIG. 11 comprises tasks 1102, 1104, 1106, 1108, and 1110. It will be clear to those skilled in the art, after reading this specification, how to make and use alternative embodiments of the present invention in which at least some of tasks 1102 through 1110 can be performed concurrently, simultaneously, at different times, or in a different order.

At task 1102, the user of telecommunications terminal 102 returns to the first location-of-interest. While physically at this location, the user executes application software 204 on terminal 102. In response to executing the application software, terminal 102 displays a soft-button labeled, for example, “locate others,” to the user on display 210. At time T₃, and while physically at the first location-of-interest, the user invokes the “locate others” button by performing, for example, and without limitation, a single tap of the button. This single tap of the button represents a third command for terminal 102 to retrieve information from data-processing system 106, as will be described in more detail below, with reference to task 1104 and task 1106.

At task 1104, terminal 102 obtains a Global Positioning System (GPS) coordinate or an estimate of its own geo-location, as described in task 506. Once obtained, terminal 102 determines that the user has returned to the first location-of-interest based on the GPS coordinate or estimated geo-location.

At task 1106, terminal 102 transmits a request to data-processing system 106 via telecommunications network 108. The request includes the GPS coordinate or estimated geo-location obtained at task 1104. When data-processing system 106 receives the request from terminal 102, data-processing system 106 searches memory 302 to determine whether the location-of-interest of other journal entries, created by other users, is within a predefined distance of the GPS coordinate or estimated geo-location. Based on this determination, data-processing system 106 transmits a response to terminal 102 that includes the location-of-interest of the other user's journal entry.

At task 1108, terminal 102 receives the response to the request from data-processing system 106 via network 108. The response comprises the location-of-interest of the other user's journal entry, which is within a predefined distance of the GPS coordinate or estimated geo-location.

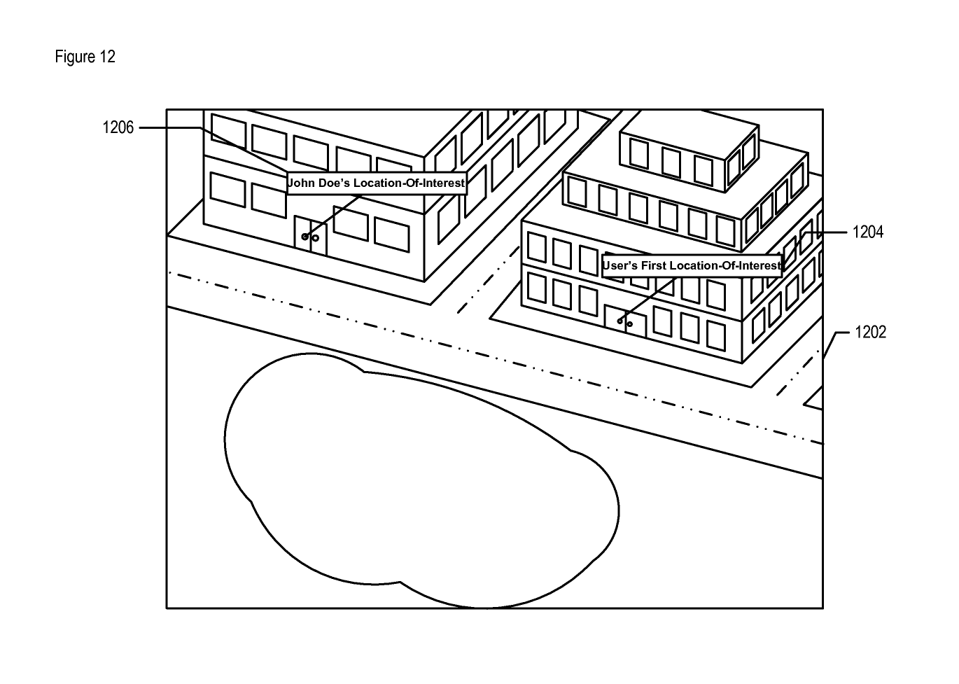

At task 1110, terminal 102 displays the user's first location-of-interest and the location-of-interest of the other user superimposed on a map, as will be discussed in more detail with reference to FIG. 12. It will be clear to those skilled in the art, after reading this specification, how to make and use alternative embodiments of the present invention in which terminal 102 displays only the location-of-interest of other users superimposed on the map.

Although task 1102 through task 1110 are directed to displaying the first location-of-interest on a map, it will be clear to those skilled in the art, after reading this specification, how to make and use the present invention in which task 1102 through task 1110 are similarly performed by terminal 102 for displaying the second location-of-interest on the map.

FIG. 12 depicts a user's location-of-interest and another user's location-of-interest superimposed on a map displayed by a telecommunications terminal in accordance with an illustrative embodiment of the present invention.

When the response is received at task 1008, terminal 102 displays the user's first location-of-interest 1204 and the other user's location-of-interest 1206 superimposed on map 1202. In the illustrative embodiment, the other user's location-of-interest 1206 is within, for example, and without limitation, a predefined distance of fifty feet of the first location-of-interest. The predefined distance can be pre-programmed into application software 204 or defined by the user via terminal 102.

In the illustrative embodiment, the user of terminal 102 can select the other user's location-of-interest 1206 on map 1202. Once selected, terminal 102 transmits a request to data-processing system 106. In response to transmitting the request, terminal 102 receives the journal entry associated with the other user's location-of-interest 106 and displays it on display 210. The other user's journal entry includes, for example, calendrical time, text, audio recordings, photos, videos, etc. The user of terminal 102 can read the text of that journal entry and select the audio recordings, photos, and videos to listen or view them on terminal 102. This feature of the present invention is advantageous because it enables the user of terminal 102 to obtain more information about other locations-of-interests that are within the vicinity of his current geo-location.

It will be clear to those skilled in the art, after reading this specification, how to make and use alternative embodiments of the present invention in which map 1202 can be any one of, or any combination of, a political map, a physical map, a topographical map, a road map, a satellite map, a street map, etc.

Although the description of FIG. 12 is directed to the first location-of-interest, it will be clear to those skilled in the art, after reading this specification, how to make and use the present invention in which the description of FIG. 12 also applies to the second location-of-interest.

What is claimed is:

1. A method comprising:
receiving, by a terminal, a first command from a user at time T₁, wherein the first command stores a first calendrical time and a first media type in the terminal, thereby creating a first mnemonic for a first location-of-interest;
receiving, by the terminal, a second command from the user at time T₂, wherein the second command stores a second calendrical time and a second media type in the terminal, thereby creating a second mnemonic for a second location-of-interest, wherein T₂ is at an arbitrary time after T₁;
displaying, by the terminal, a list that includes the first mnemonic and the second mnemonic; and
creating, by the terminal, a journal entry based on at least one of the first mnemonic and the second mnemonic.

2. The method of claim 1, wherein the first command comprises a single tap of a soft button on a screen of the terminal.

3. The method of claim 1, wherein the list is organized and displayed to the user based on geo-location.

4. The method of claim 1, wherein the first command simultaneously records the first calendrical time and activates a recording feature of the terminal for a predefined time.

5. The method of claim 1, wherein the first media type is an audio recording, and wherein creating the journal entry based on the first mnemonic comprises communicating, by the terminal, the audio recording to the user.

6. The method of claim 1, wherein the journal entry is created with authorization information, and wherein the authorization information instructs a data-processing system to make the journal entry publicly available to all users.

7. The method of claim 1, wherein the journal entry is created with authorization information, and wherein the authorization information instructs a data-processing system to make the journal entry available to only a selected group of users.

8. The method of claim 1, wherein the second command also stores a third media type, wherein the second media type is an audio recording and the third media type is a photo of the second location-of-interest, and wherein creating the journal entry based on the second mnemonic comprises:
(i) communicating, by the terminal, the audio recording to the user, and
(ii) displaying, by the terminal, the photo of the second location-of-interest to the user.

9. The method of claim 1, wherein creating the journal entry based on the first mnemonic comprises:
receiving, by the terminal, a third command from the user, wherein the third command is to use at least one of the following as the journal entry:
(i) text provided by the user that describes the first location-of-interest,
(ii) an audio recording stored in the terminal that describes the first location-of-interest,
(iii) an image of the first location-of-interest stored in the terminal, and
(iv) a video of the first location-of-interest stored in the terminal;
wherein the journal entry is transmitted from the terminal to a data-processing system after receiving the third command, and wherein the data-processing system updates an electronic journal of the user using the journal entry.

10. The method of claim 1 further comprising:
transmitting, by the terminal, a request to a location-aware service in response to receiving the first command at time T₁, wherein the request is to obtain a Global Positioning System (GPS) coordinate of the terminal at time T₁;
receiving, by the terminal, in response to the request, the GPS coordinate from the location-aware service;
associating, by the terminal, the GPS coordinate with the first calendrical time and the first media type; and
storing, by the terminal, the association in a memory of the terminal as the first mnemonic.

11. The method of claim 1 further comprising:
transmitting, by the terminal, a request to a location-aware service in response to receiving the second command at time T₂, wherein the request is to obtain a Global Positioning System (GPS) coordinate of the terminal at time T₂;
receiving, by the terminal, a list of Service Set Identifiers (SSIDs) broadcasted by a network at time T₂;
deducing a geo-location of the terminal based on the list of SSIDs when the terminal fails to receive a response to the request;
associating, by the terminal, the geo-location with the second calendrical time and the second media type; and
storing, by the terminal, the association in a memory of the terminal as the second mnemonic.

12. The method of claim 1, wherein the first mnemonic is displayed in the list under an identifier;
wherein selecting the identifier displays the first location-of-interest on a map based on a Global Positioning System coordinate obtained by the terminal at time T₁; and
wherein the user is given an option by the terminal to assign a name to the first location-of-interest when displayed on the map.

13. The method of claim 1, further comprising:
transmitting, by the terminal, a request to a data-processing system at time T₃, wherein the request is transmitted in response to receiving a third command from the user at the first location-of-interest, and wherein T₃ is at an arbitrary time after T₁ and T₂;
receiving, by the terminal, a response from the data-processing system; and
displaying, by the terminal, a third location-of-interest of another user superimposed on a map of the terminal.

14. The method of claim 13, wherein the third location-of-interest is within a predefined distance of the first location-of-interest, and wherein the third location-of-interest is from a journal entry created by the other user.

15. The method of claim 13, wherein the third location-of-interest is displayed on the map with the first location-of-interest.

16. The method of claim 1, wherein the second mnemonic is displayed in the list under an identifier;
wherein selecting the identifier displays a list of Service Set Identifiers (SSIDs) obtained by the terminal at time T₂; and
wherein the user assigns a name to the second location-of-interest using the list of SSIDs as a third mnemonic.
